(19) United States
(12) Patent Application Publication
(10) Pub. No.: US 2010/0000015 A1
(43) Pub. Date: Jan. 7, 2010

(54) DEVICE FOR LIFTING AND TRANSFERRING BODIES

(76) Inventor: Stéphane Althaus, Glion (CH)

Correspondence Address: NIXON & VANDERHYE, PC, 901 NORTH GLEBE ROAD, 11TH FLOOR, ARLINGTON, VA, 22203, US

(21) Appl. No.: 12/439,877

(22) PCT Filed: Sep. 5, 2007
(86) PCT No.: PCT/IB2007/053571

§ 371 Date: Apr. 14, 2009

(30) Foreign Application Priority Data
Sep. 6, 2006 (IB) PCT IB2006 053132

(51) Int. Cl. A61G 7/10

(52) U.S. Cl. 5/83.1

(57) ABSTRACT

Device for lifting and transferring bodies comprising a base element consisting of two identical parallelograms having a common central width and movable translationally in a vertical direction, each corner of the parallelograms forming a hinge point about which its constituent length and width can rotate freely; the device also comprising first and second means for holding the body, these being connected to the two respective external lower corners of the base element.

### FIELD OF THE INVENTION

The present invention relates to the lifting and transfer of bodies in a hospital environment or any other similar environment in which bodies must be moved.

### PRIOR ART

Various devices exist for lifting and moving bodies. Such devices are described, by way of example, in the following patent publications: GB 2 356 384, U.S. Pat. No. 2,449,898, U.S. Pat. No. 2,203,732, U.S. Pat. No. 1,948,611.

### GENERAL DESCRIPTION OF THE INVENTION

The problem that the present invention proposes to solve lies in improving devices of the prior art.

In the invention, the solution to the aforementioned problem consists of a device for lifting and transferring bodies comprising a basic element consisting of two identical parallelograms having a common short side, which is central and mounted to be able to move translationally in a vertical direction, each corner of the parallelograms forming a hinge point about which the long side and the short side which form it can be freely turned; the device furthermore comprising first and second means for gripping the body which are respectively attached at the two lower outer corners of the basic element.

As can be better observed in the figures attached to the present application, when a tensile force is exerted from the bottom to the top on the central part of the device according to the invention, for example by means of a hoist, the central short side moves upwards and the lower outer ends of the parallelograms move closer to one another in an approximately horizontal direction, thus enabling the body to be gripped.

Advantageously, said gripping means are mounted so as to pivot about said lower corners and each comprise an upper end and a lower end, said upper end being attached to and mounted so as to slide on the central short side, said lower end comprising a support member arranged in a horizontal direction.

The device according to the invention is preferably provided with two basic elements positioned at each end of the device.

More than two basic elements may also be used.

According to a preferred variant of the invention, the basic elements are attached to each other by means of a horizontal segment, the ends of which are attached to one of said corners.

In one embodiment, a horizontal segment is attached to the upper central corners, said horizontal segment furthermore comprising a gripping element, for example a ring, designed to be gripped by a grasping element, for example a hook, of a lifting system such as a hoist.

Advantageously, the catch element is mounted so as to slide along said horizontal segment, which allows the stability of the device to be adjusted according to the center of gravity of the body.

According to one particularly advantageous embodiment, the device comprises blocking means, for example a dashpot, designed so as to block or unblock the movement of the gripping means.

The support member is preferably elongate and its short side has a thickness that decreases in the direction of the center of the device. This makes inserting the support member below the patient easier.

### DETAILED DESCRIPTION OF THE INVENTION

The invention is described in greater detail hereafter by means of examples illustrated by the following figures:

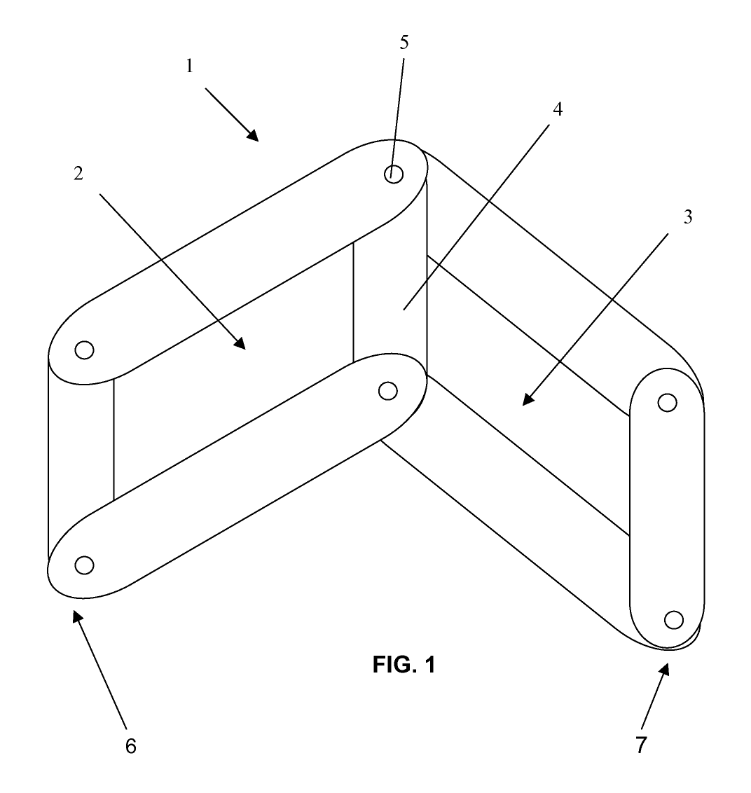

FIG. 1 is a schematic representation of the basic element according to the invention;

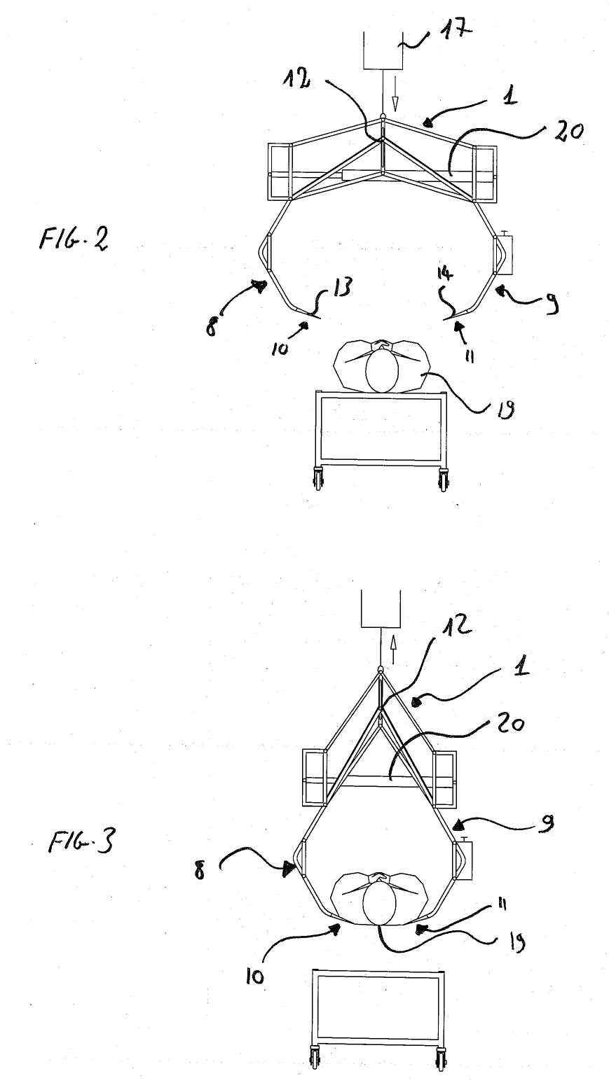

FIG. 2 shows an example of a device according to the invention before gripping a body;

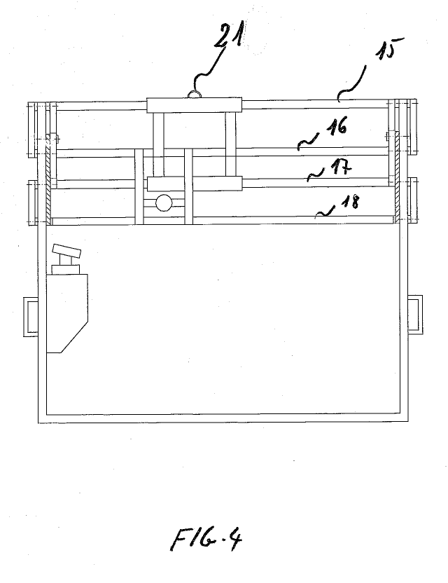

FIG. 3 shows the device of FIG. 2 once a body has been gripped;

FIG. 4 illustrates a side view of the device of FIGS. 2 and 3;

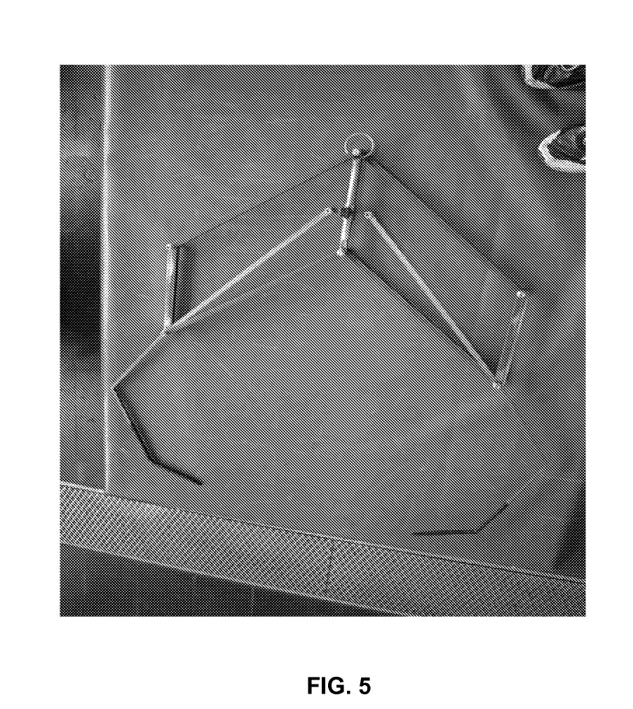

FIG. 5 represents a basic element similar to that of FIG. 1 with which means for gripping the body are associated. The central short side of the parallelograms is moreover a gripping ring designed to receive a grasping element such as a hook of a hoist;

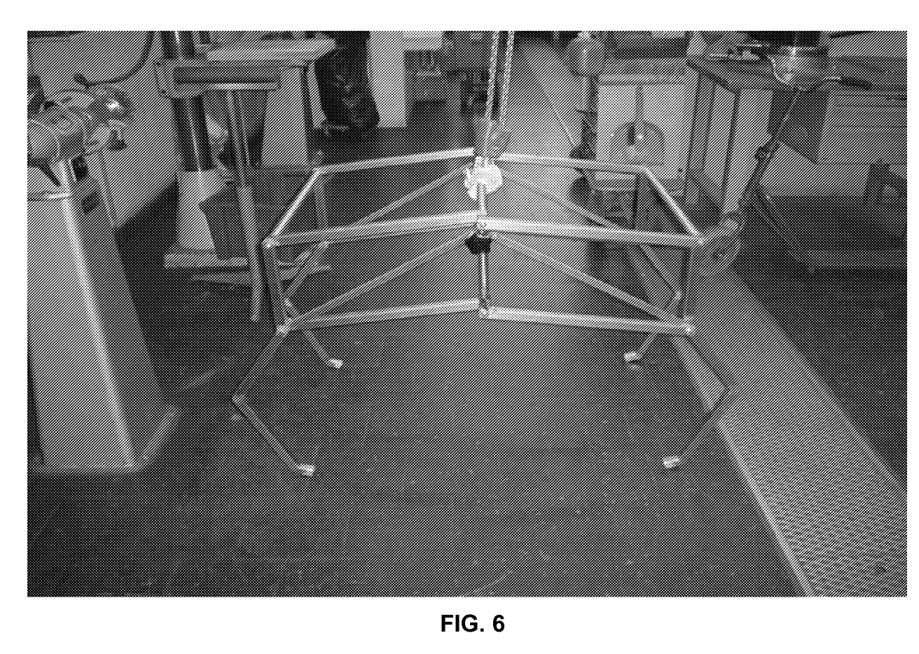

FIG. 6 represents an exemplary embodiment of a device according to the invention consisting of two basic elements described in FIG. 2 connected to one another by a horizontal tube assembly;

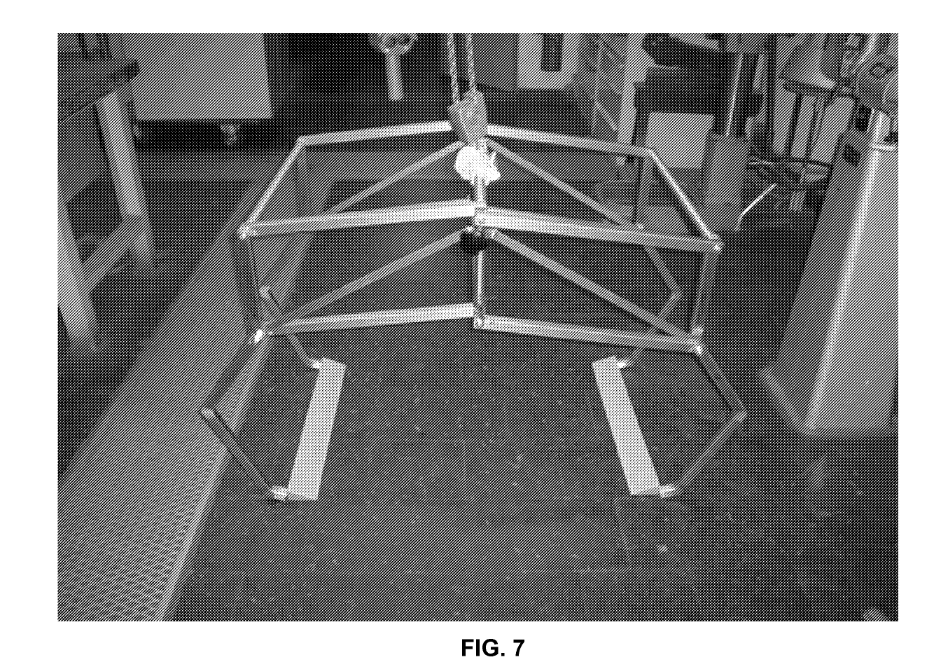

FIG. 7 represents a device identical to that of FIG. 3 with which two support members forming the gripping means are associated;

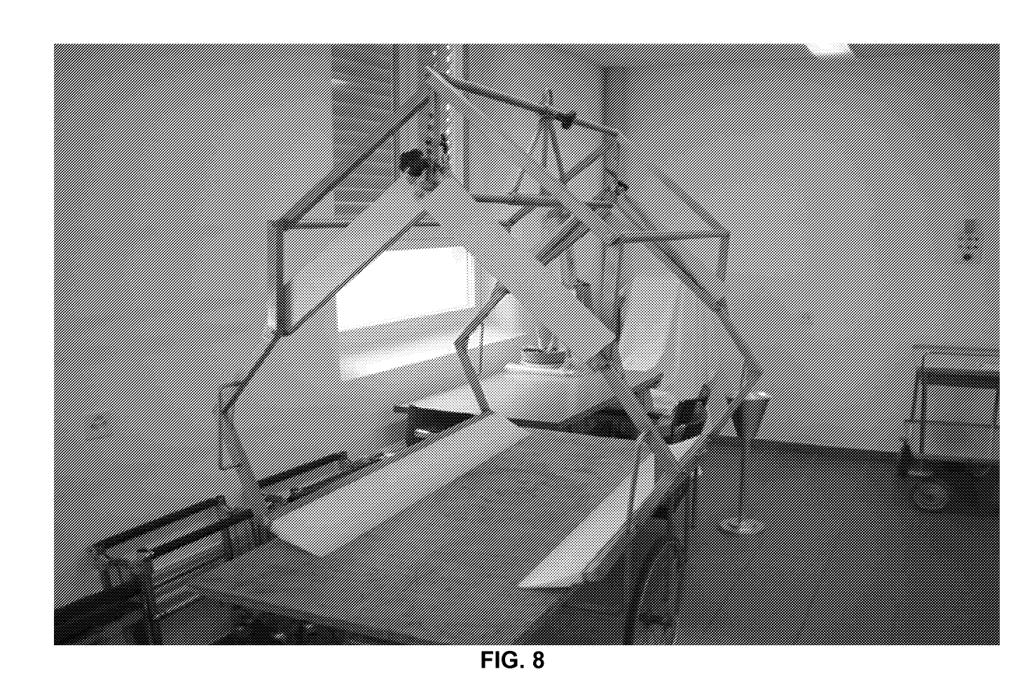

FIG. 8 represents a device similar to that of FIG. 4 in a half-open position;

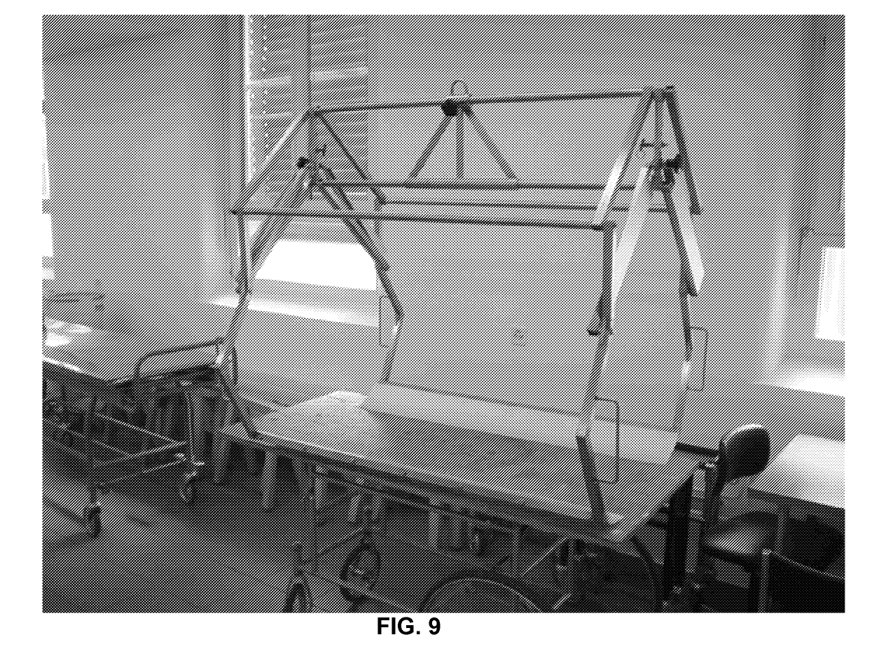

FIG. 9 represents the device of FIG. 5 viewed from the side;

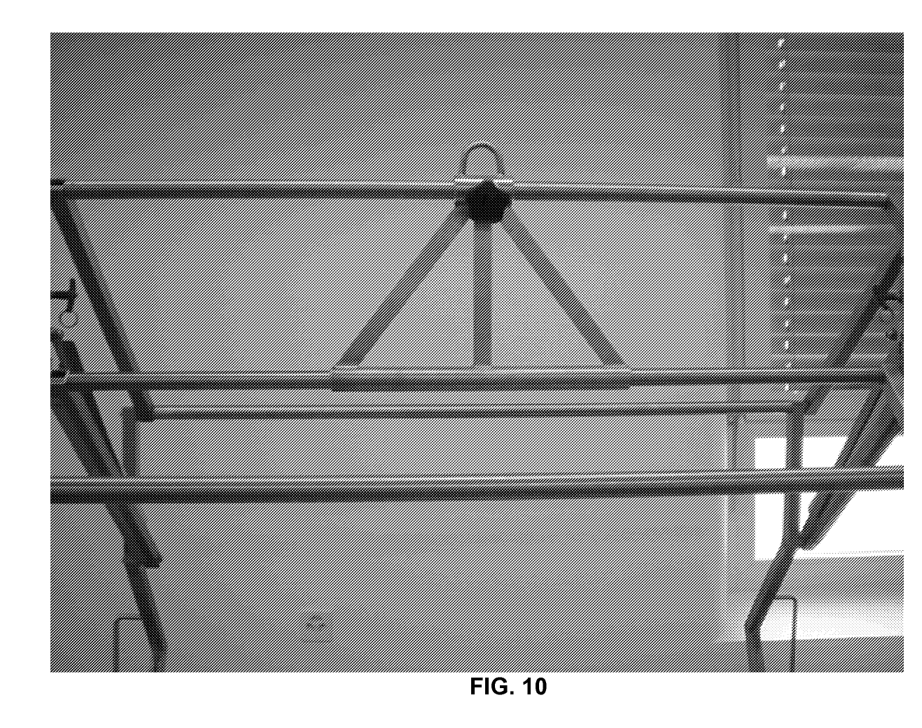

FIG. 10 represents a gripping element in the form of a loop;

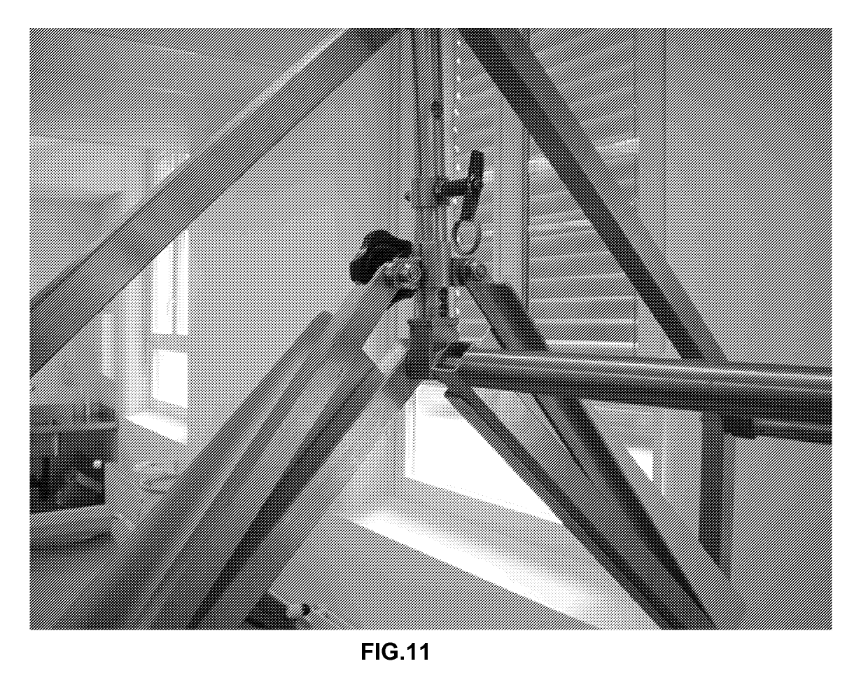

FIG. 11 represents an enlargement at the intersection between the central short side and the upper ends of the gripping means;

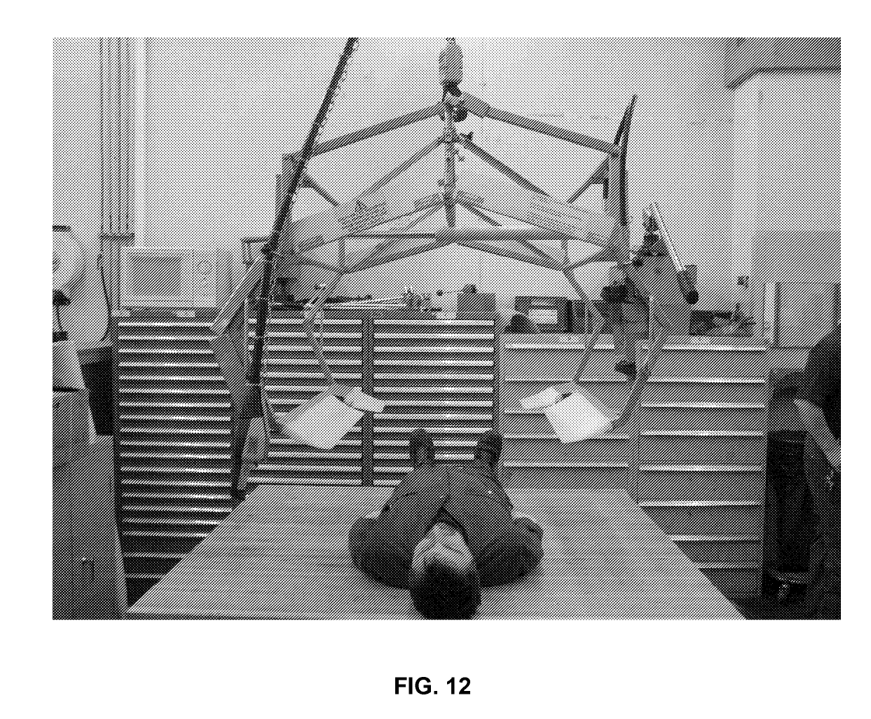

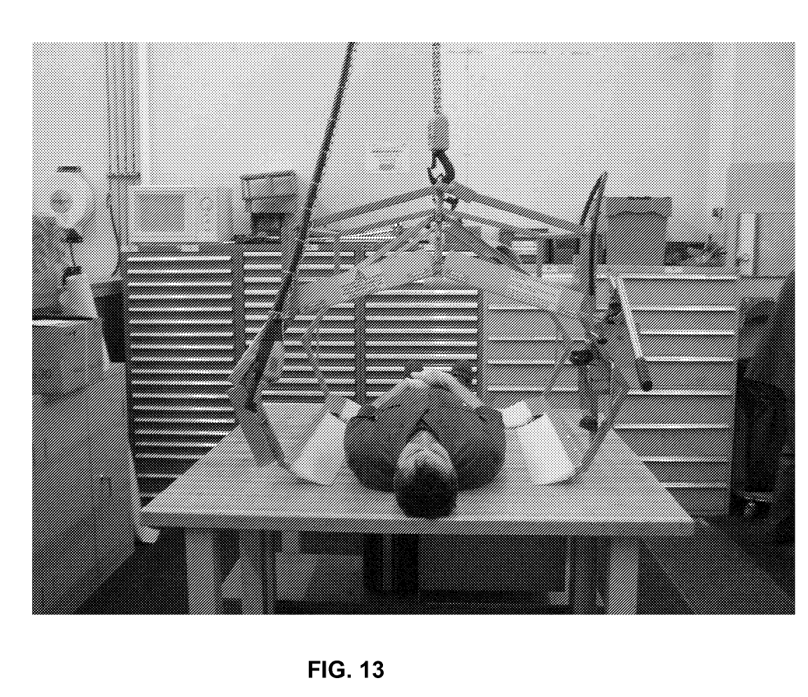

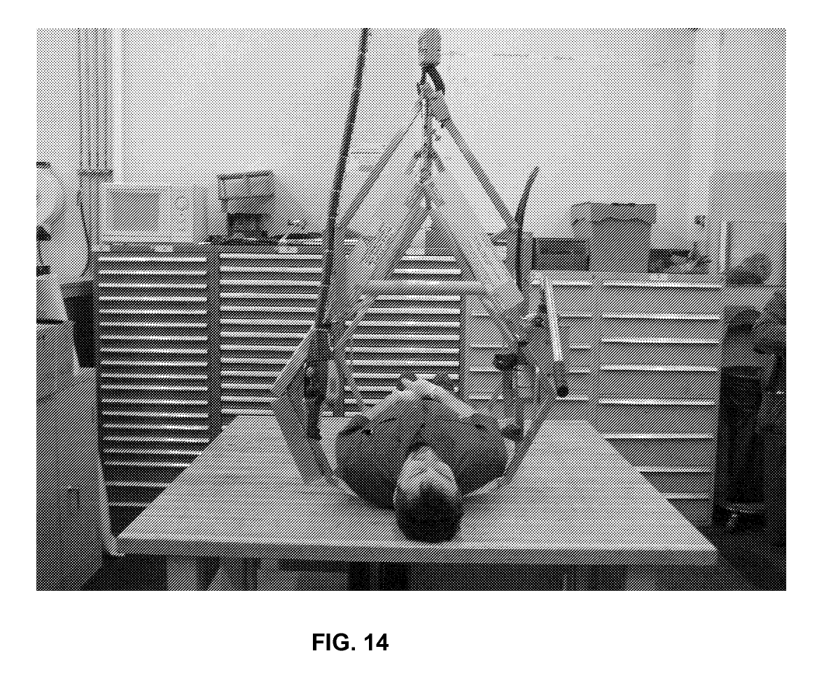

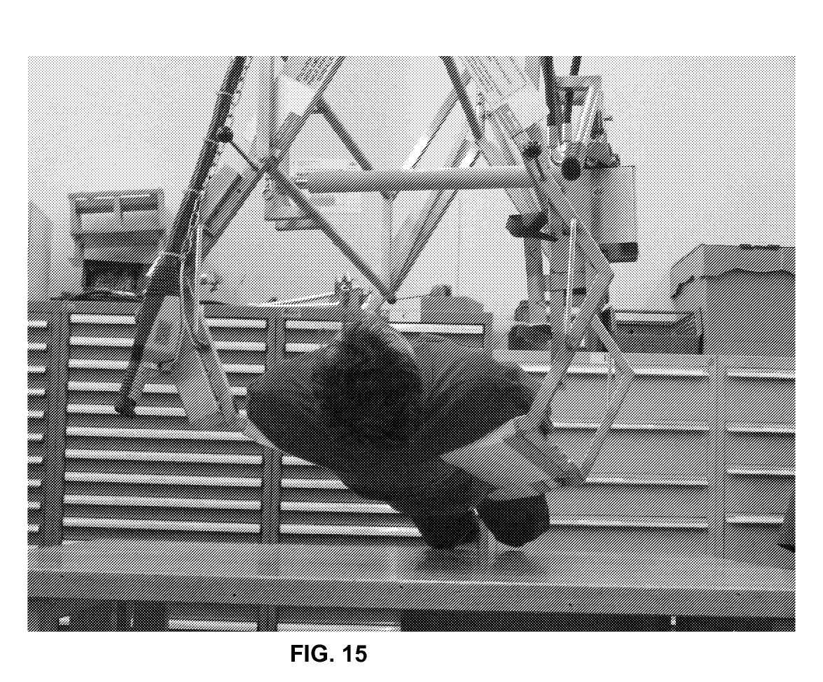

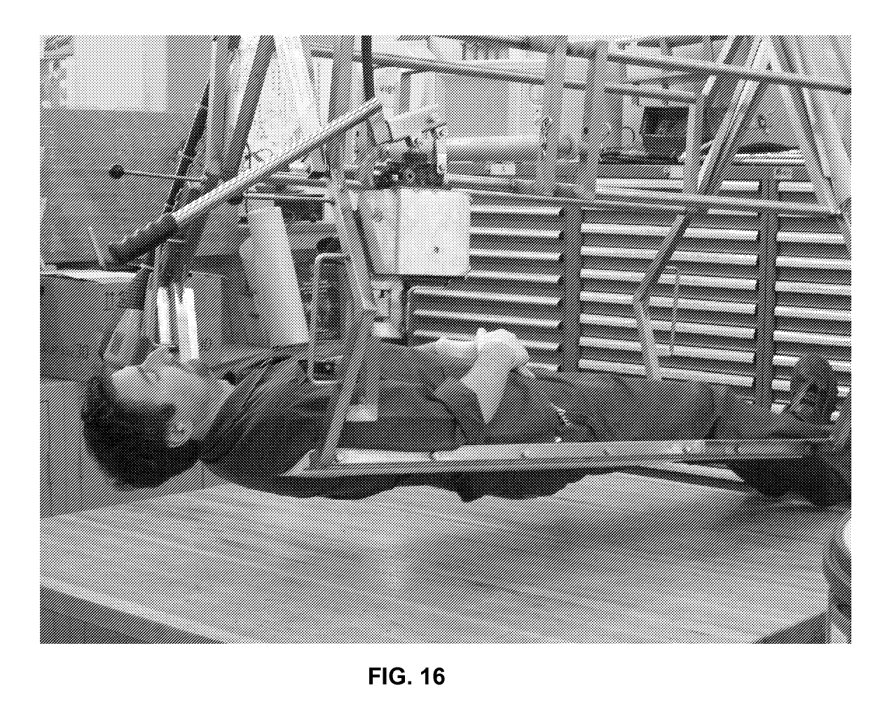

FIGS. 12 to 16 illustrate various steps of lifting by means of a device similar to the devices of the preceding figures, but which differs in that it comprises a dashpot equipped with a lever; and

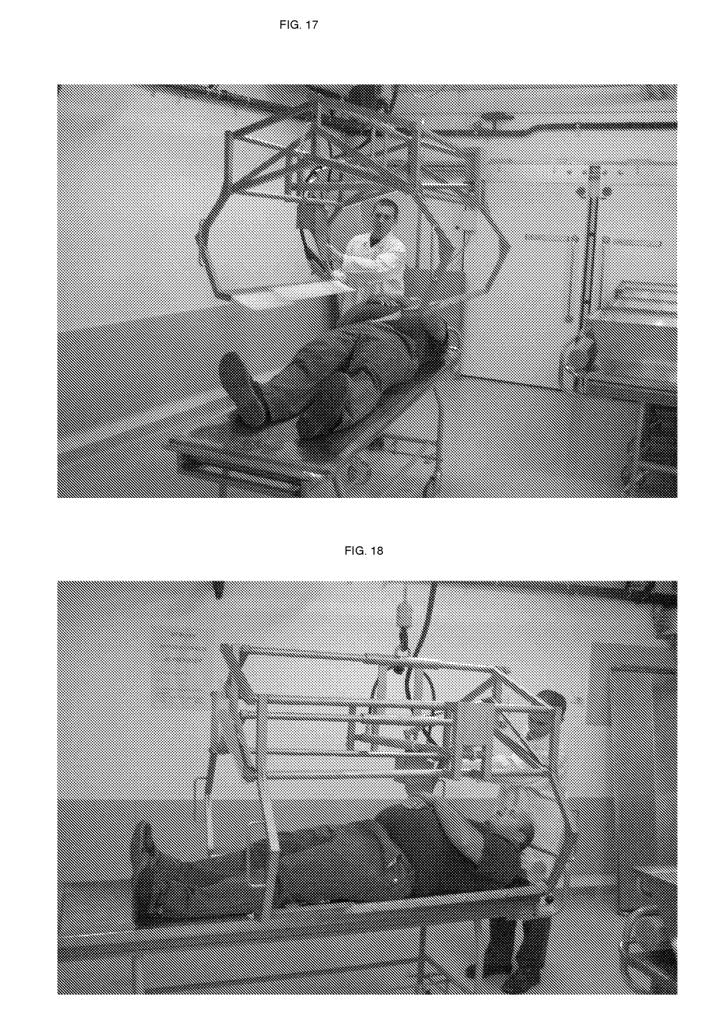

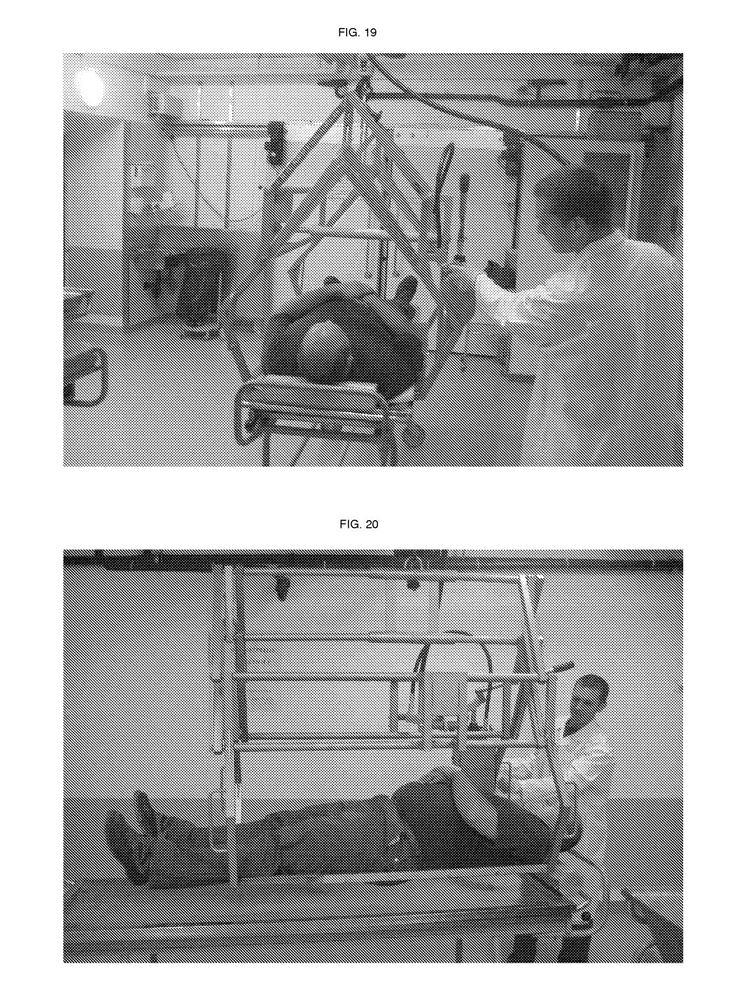

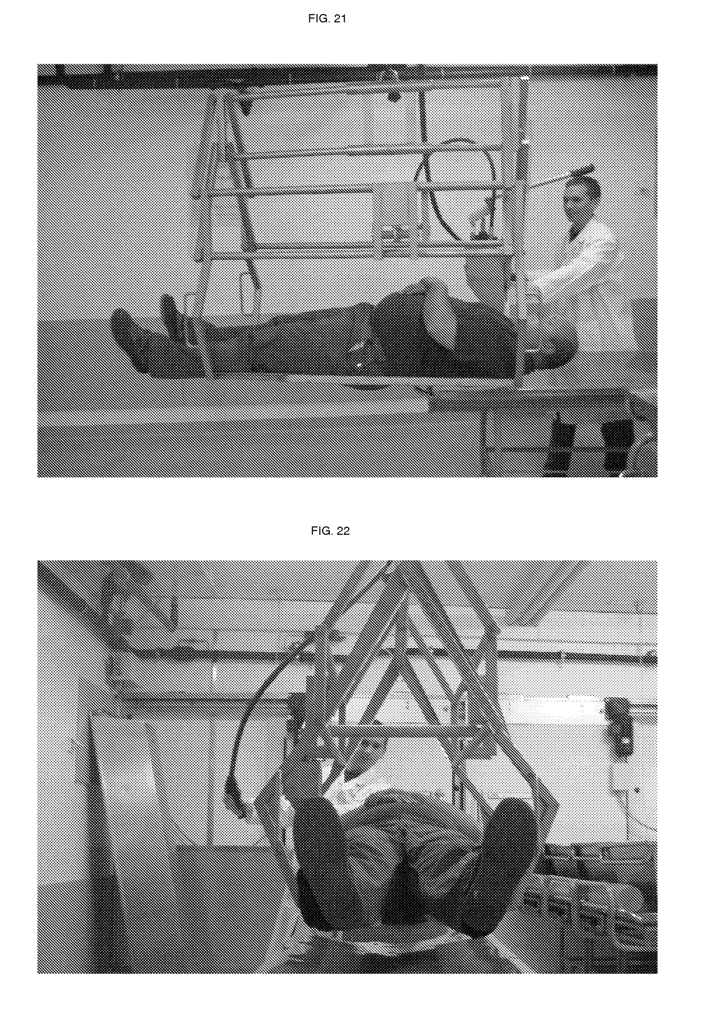

FIGS. 17 to 22 illustrate various steps of lifting by means of a device similar to the device of FIGS. 12 to 16.

The basic element 1, illustrated schematically in FIG. 1, consists of two parallelograms 3, 4 of identical dimensions and having a common short side 4 which is central and mounted to be able to move translationally in a vertical direction, each corner of the parallelograms forming a hinge point 5 about which the long side and the short side which form it can be freely turned.

An element for gripping a body 8, 9 (see FIGS. 2 and 3) is rotationally attached at each lower outer corner 6, 7; the lower end 10, 11 of said element consists of a support member 13, 14 designed to support a body 19. The upper end 12 of each gripping element 8, 9 is attached to and mounted so as to slide on the common short side 4 of the two parallelograms 3, 4.

In this way, an upwards tension of the central part 4, 12 of the device causes two successive steps, namely the closure of the device on the body followed by lifting of the latter.

The device described in the present example comprises two basic elements 1 positioned at each end of the device (see FIG. 4). The two basic elements are joined to one another by means of horizontal segments 15 to 18.

A gripping element in the form of a ring 21 is mounted so as to slide along the horizontal segments 15 to 18.

The use of blocking means such as a dashpot 20 makes it possible to keep the gripping means 8, 9 open and to prevent the body 19 being squashed once the gripping means 8, 9 have come to stop against the body 19. Finally, the blocking means 20 enable the opening of the gripping means 8, 9 once the body 19 is resting on the gripping means 8, 9.

The upper structure of the device illustrated in particular in FIGS. 10 to 16 makes it possible to obtain a horizontal equilibrium along the two axes when the assembly is suspended from the hook of a hoist.

It should be pointed out that the device according to the invention operates without an energy source other than the power supply of the hoist.

Furthermore, the device according to the invention may be used to grip bodies positioned on any type of surface (stainless steel, mattress, waterbed, airbed, etc.)

The material of the gripping means is chosen depending on its strength and its sliding on the surface on which the body is positioned.

The corners and the long sides of the tubes may easily be adapted to the size of bodies and to the available space (autopsy and preparation table, small-sized location, etc.).

The present invention furthermore comprises other advantages over devices of the prior art. In particular it makes it possible for a single person to lift and to transfer a body. A body of 200 kg, or even more, can easily be manipulated. In addition, the gripping of the body can be carried out very gently, without damaging the body, thus enabling the device according to the invention to be used to deposit a body in a coffin. Finally, thanks to the blocking means, any accidental opening of the device during lifting or transfer is avoided.

The invention is obviously not limited to the examples illustrated in the present application.

In the following text, “body” should primarily be understood as “corpse”. The device is therefore particularly intended to be used in an environment such as a morgue, chapel or autopsy room.

The invention may, however, also be used for living human or animal beings.

1 . A device for lifting and transferring bodies comprising a basic element consisting of two identically sized parallelograms having a common short side, which is central and mounted to be able to move translationally in a vertical direction, each corner of the parallelograms forming a hinge point about which the long side and the short side which form it can be freely turned; the device furthermore comprising first and second means for gripping the body which are respectively attached at the two lower outer corners of the basic element.

2. The device as claimed in claim 1, in which said gripping means are mounted so as to pivot about said lower corners and each comprise an upper end and a lower end, said upper end being attached to and mounted so as to slide on the central short side, said lower end comprising a support member designed to support a body.

3. The device as claimed in claim 1, comprising two basic elements positioned at each end of the device.

4. The device as claimed in claim 3, in which the basic elements are attached to each other by means of a horizontal segment, the ends of which are attached to one of said corners.

5. The device as claimed in claim 4, in which a horizontal segment is attached to the upper central corners, said horizontal segment furthermore comprising a gripping element, for example a ring, designed to be gripped by a grasping element, for example a hook, of a lifting system such as a hoist.

6. The device as claimed in claim 5, in which the catch element is mounted so as to slide along said horizontal segment.

7. The device as claimed in claim 1, comprising blocking means designed so as to block or unblock the movement of the gripping means.

8. The device as claimed in claim 1, in which the blocking means consist of a dashpot.

9. The device as claimed in claim 2, in which said support member is elongate and its short side has a thickness that decreases in the direction of the center of the device
